(19) United States
(12) Patent Application Publication
(10) Pub. No.: US 2007/0029142 A1
(43) Pub. Date: Feb. 8, 2007

(54) Brake system including ball screw and nut assembly

(76) Inventors: David B. Drennen, Bellbrook, OH (US); Ronald G. Smith, New Carlisle, OH (US); Ernest R. Siler, Springboro, OH (US); Paul Rymoff, Bellbrook, OH (US); Harald Klode, Centerville, OH (US); Bryan P. Riddiford, Dayton, OH (US)

Correspondence Address: Delphi Technologies, Inc., M/C 480-410-202, P.O. Box 5052, Troy, MI, 48007-5052, US

(21) Appl. No.: 11/196,210

(22) Filed: Aug. 3, 2005

(51) Int. Cl. F16D 55/08

(52) U.S. Cl. 188/72.7; 188/72.1

(57) ABSTRACT

A ball screw and nut assembly includes a ball screw component having a threaded outer surface and a ball nut component having a bore in which the ball screw component is received. The ball nut component includes a threaded inner surface that cooperates with the threaded outer surface of the ball screw component to achieve axial movement of the ball nut component between a fully retracted position and a fully extended position as the ball screw rotates relative to the ball nut. A positive stop prevents rotation of the ball screw component relative to the ball nut component at an axial position between the fully retracted position and the fully extended position as the ball nut component is retracted.

### TECHNICAL FIELD

The present application relates generally to braking systems, and more particularly to a braking system including a ball screw and nut assembly.

### BACKGROUND

Various types of brake systems are known for use in automotive vehicles. Such brake systems include, for example, hydraulic brakes, anti-lock brakes and electric brakes. Some electric brake systems often utilize caliper mechanisms that incorporate an electric motor and a gear assembly positioned within the caliper housing. The electric motor and gear assembly are used to drive an inner brake pad against a brake rotor disc of a vehicle. A second, outer brake pad mounted to the caliper housing is positioned on an opposite side of the rotor disc. During braking, the inner brake pad is forced against the rotor disc and a resulting reactionary force pulls the outer break pad into engagement with the opposite side of the disc. Engagement of the inner and outer brake pads slows or stops rotation of the rotor disc, and, in turn, slows the vehicle or holds the vehicle in a fixed position.

In some instances, drive mechanisms include a ball screw assembly for use in moving the brake pads. A ball screw assembly typically includes a ball screw that is received in a bore of a ball nut. The ball screw can be rotated by the motor and that rotation of the ball screw can be used to drive the ball nut axially toward and away from the inner brake pad.

### SUMMARY

In an aspect, a ball screw and nut assembly includes a ball screw component having a threaded outer surface and a ball nut component having a bore in which the ball screw component is received. The ball nut component includes a threaded inner surface that cooperates with the threaded outer surface of the ball screw component to achieve axial movement of the ball nut component between a fully retracted position and a fully extended position as the ball screw rotates relative to the ball nut. A positive stop prevents rotation of the ball screw component relative to the ball nut component at an axial position between the fully retracted position and the fully extended position as the ball nut component is retracted.

In another aspect, a brake apparatus includes a housing, a ball screw component disposed in the housing and having a threaded outer surface and a ball nut component disposed in the housing and having a bore in which the ball screw component is received. The ball nut component includes a threaded inner surface that cooperates with the threaded outer surface of the ball screw component to achieve axial movement of the ball nut component between a fully retracted position and a fully extended position as the ball screw component rotates relative to the ball nut component. A positive stop prevents rotation of the ball screw component relative to the ball nut component at an axial position between the fully retracted position and the fully extended position as the ball nut component is retracted.

In another aspect, a method of actuating a brake caliper during a braking operation is provided. The method includes extending a ball nut component of a ball screw and nut assembly relative to a ball screw component by rotating the ball screw component in a first direction relative to the ball nut component. The ball nut component of the ball screw and nut assembly is retracted relative to the ball screw component toward a fully retracted position by rotating the ball screw component in a second direction opposite the first direction relative to the ball nut component. Rotation of the ball screw component in the second direction is stopped using a positive stop thereby stopping axial retraction of the ball nut component relative to the ball screw component prior to the ball nut component reaching the fully retracted position.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a diagrammatic, section view of an embodiment of an electric brake caliper;

FIG. 2 is a perspective view of an embodiment of a ball screw and nut assembly for use in the electric brake caliper of FIG. 1;

FIG. 2A is a detail view of cooperating stop members of the ball screw and nut assembly of FIG. 2;

FIG. 3 is an exploded view of another embodiment of a brake caliper;

FIG. 4 is a diagrammatic, section view of the brake caliper of FIG. 3 as assembled;

FIG. 5 is a perspective view of an embodiment of a ball screw and nut assembly for use in the brake caliper of FIG. 3;

FIG. 6 is an exploded view of another embodiment of a ball screw and nut assembly; and

FIG. 7 is an assembled, end view of the ball screw and nut assembly of FIG. 5.

### DETAILED DESCRIPTION

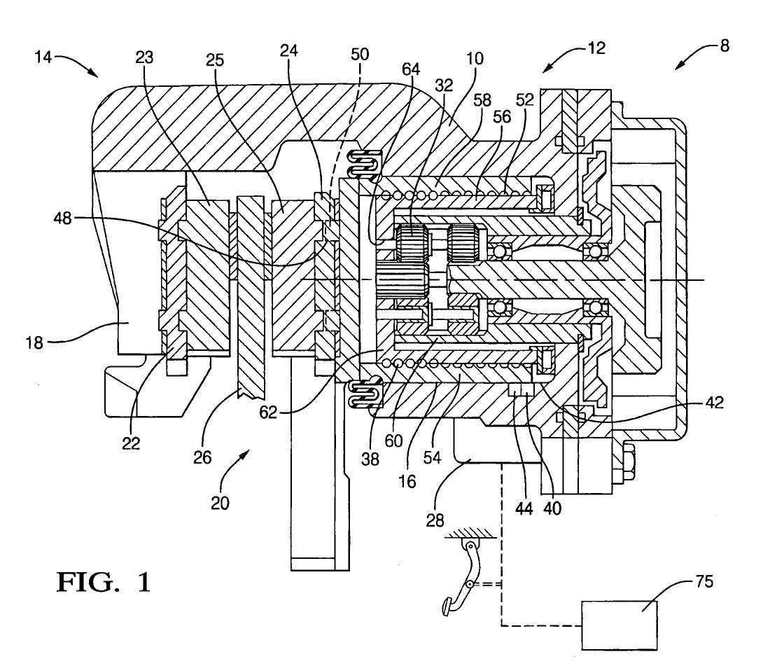

Referring to FIG. 1, an embodiment of an electric brake caliper 8 includes a brake caliper housing 10 having a cylindrical housing portion 12 and an L-shaped bridge portion 14 extending axially from the cylindrical housing portion 12. The cylindrical housing portion 12 includes a cylindrical bore 16 for containing a drive mechanism of the electric brake caliper. The L-shaped bridge portion 14 of the caliper housing 10 includes a flange 18 extending therefrom to form a rotor channel 20 axially between the flange 18 and the cylindrical housing portion 12. The flange 18 seats an outer brake pad 22 with shoe 23 thereon. An inner brake pad 24 with shoe 25 is mounted to a drive mechanism including a ball screw and nut assembly 54 for axial reciprocation toward and away from the rotor channel 20, such that when the ball screw and nut assembly 54 is actuated, the inner brake pad 24 will be forced against a rotor disc 26 extending into the rotor channel 20.

The ball screw and nut assembly 54 includes a ball screw component 56 and a ball nut component 58. The ball nut component 58 seats the inner brake pad 24, thereby acting as the piston of the electric brake caliper drive mechanism. The ball screw component 56 includes a cylindrical bore 60 for receiving a gear train 32. An annular wall 62 projects radially inwardly from the cylindrical bore 60, approximate a longitudinal end of the screw component 56 near the inner brake pad 24. The annular wall 62 includes a central bore 64 for allowing a drive shaft to pass therethrough. Certain components of the illustrated drive mechanism are further described in U.S. patent application Ser. No. 10/639,946, filed Aug. 13, 2003, the details of which are incorporated by reference as if fully set forth herein.

Gear train 32 is coupled to the ball screw component 56. A pin 40 extends outwardly from an outer surface 42 of ball nut component 58 and is received by a slot 44 to inhibit rotation of the ball nut component relative to housing 10 and enabling rotation of the ball screw component 56 relative to the ball nut component. In some embodiments, as shown by the dotted lines, brake pad 24 includes a groove 48 that receives a projection 50 extending outwardly from an end of the ball screw and nut assembly 54 to inhibit rotation of the ball nut component 56.

In operation, motor 28 imparts rotation to the ball screw component 56 through gear train 32, which, in turn, causes the ball nut component 58 to travel axially towards or away from the rotor channel 20, depending upon the direction of motor output. This translation of rotational motion to linear motion results from the cooperation of respective threaded surfaces 52 of the ball screw component 56 and the ball nut component 58. In some embodiments, the ball nut component 58 and ball screw component 56 are linked using ball bearings 38 that are carried between the threaded surfaces. The ball bearings 38 transmit forces from the ball screw component 56 to the ball nut component 58 that are used to move the ball nut component axially. When the output is in a first direction, the inner brake pad 24 carried on the ball nut component 58 is forced against the rotor disc 26. When the output is in a second, opposite direction, the ball nut component 58 retracts in a direction away from the inner brake pad 24 allowing for the removal of the brake pad from the rotor disc 26.

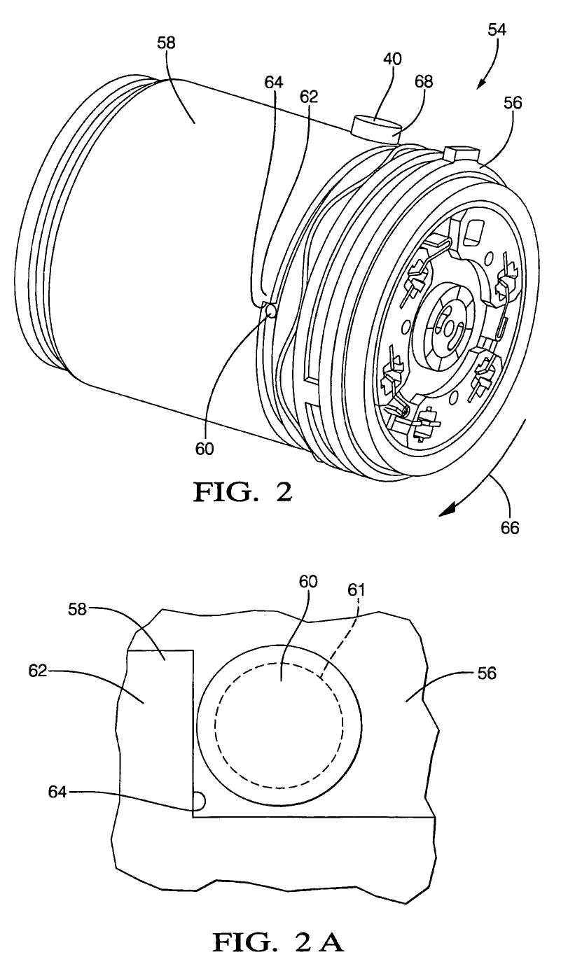

Referring now to FIGS. 2 and 2A, ball screw and nut assembly 54 includes cooperating stop members 60 and 62. Stop member 60 projects outwardly from an outer surface of the ball screw component 56. Stop member 62 is formed by a stepped portion of the ball nut component 58 that forms a seating surface 64. Stop member 62 is located such that stop member 60 engages the seating surface 64 as the ball nut component 58 is being retracted, e.g., upon brake release.

Referring particularly to FIG. 2, stop members 60 and 62 cooperate to prevent further rotation of the ball screw component 56 in the direction of arrow 66 relative to the ball nut component 58 once or soon after the stop members engage each other. This stopping of rotation by the stop members 60 and 62 also prevents additional axial retraction of the ball nut component 58 so that the ball nut component is prevented from fully retracting toward the ball screw component 56. In other words, the stop members 60 and 62 engage to prevent additional rotation of the ball screw component 58 relative to the ball nut component 56 as the ball nut component retracts to prevent further axial retraction of the ball nut component toward a fully retracted position that could be achieved in the absence of one or both of the cooperating stop members. The stop members 60 and 62, however, are located to allow sufficient rotation of the ball screw component 56 and corresponding axial retraction of the ball nut component 58 so that brake pad 24 adequately disengages rotor disc 26 (FIG. 1).

A dampening member 68 can be provided about pin 40 to soften the force, such as the shearing force exerted on the pin during operation. The dampening member 68, which may be an o-ring (e.g., formed of a compliant material such as rubber) can protect the pin 40 when the stop members 60 and 62 engage each other (e.g., at between about 100 and 200 revolutions per minute, such as about 150 revolutions per minute). While a pin 40 with o-ring arrangement is shown, any other suitable arrangement can be utilized, such as multiple, circumferentially spaced pins with (or without) damping members. As described above with reference to FIG. 1 and shown by the dotted lines, the ball nut component 56 can include a projection 50 that can be received by brake pad 24. This can serve as a second means of inhibiting rotation of the ball nut component 56 during operation. In some embodiments, a dampening member 61 (shown by dotted lines) such as an o-ring is provided to dampen force applied to stop member 60 when engaging stop member 62.

With the stop members 60 and 62 engaged, a positive stop is provided that can be used as a home position for the ball screw and nut assembly 54. This positive stop can eliminate some or all reliance on a control system (not shown) to halt axial retraction of the ball nut component 56 prior to its reaching the fully retracted position. This may result in a reduced potential for over insertion of the ball screw component 58 into the ball nut component 56, which can lead to jamming of the ball screw and nut assembly 54 in cases where the motor is unable to produce enough torque to separate the ball nut component 56 from the ball screw component 58.

Not only can stop members 60 and 62 establish a home position for the ball screw and nut assembly 54, but they can also be used to aid in the control of the brake system by a control system. For example, contact between the stop members 60 and 62 can be used to generate a signal (e.g., an increase in current or current spike) that is used by a controller 75 (FIG. 1) to identify and/or corroborate the home position of the ball screw and nut assembly 54. In some embodiments, the signal can be used by the controller 75 to initialize the braking system after the braking system has been assembled by indicating the home position.

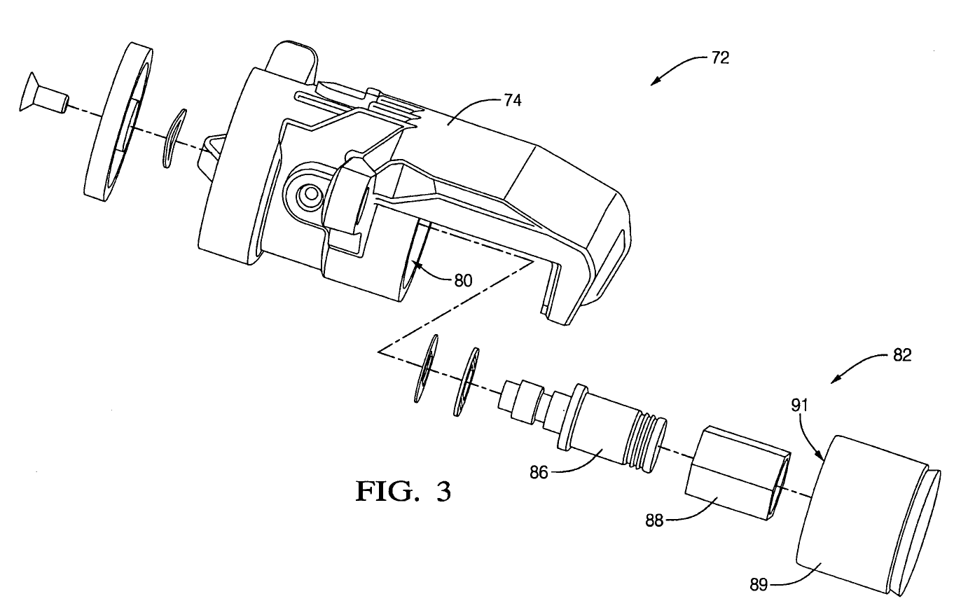

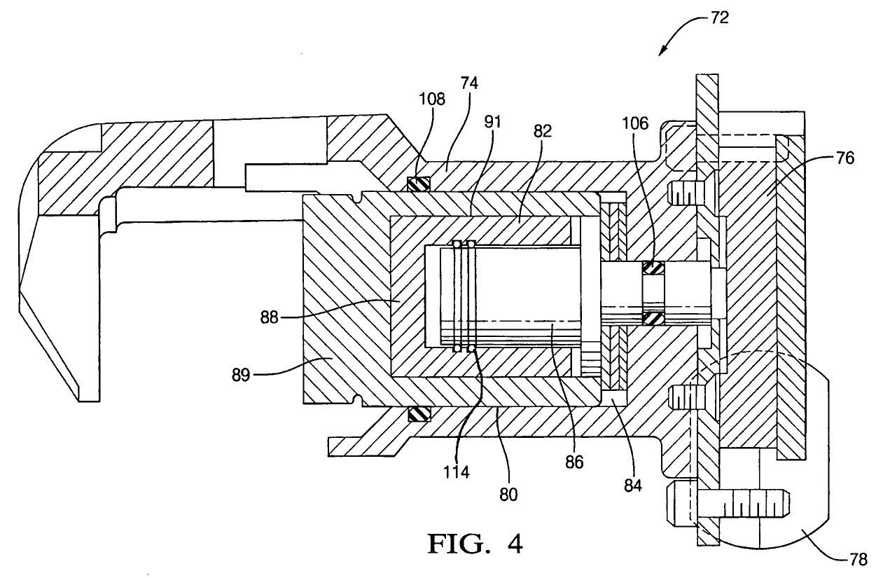

While an electric brake caliper 8 including ball screw and nut assembly 54 having a step-pin positive stop arrangement is described above, other configurations are possible. Referring to FIGS. 3 and 4, a brake caliper 72 for use in a hydraulic service brake operation and an electric park brake operation is shown. The brake caliper 72 includes a caliper housing 74, a transmission 76 and a motor 78 (FIG. 4). The caliper housing 74 includes a central bore 80 in which a ball screw and nut assembly 82 is housed.

Ball screw and nut assembly 82 includes a ball screw component 86 and a ball nut component 88. A phenolic piston 89 receives the ball nut component 88. Bore 91 of the phenolic piston 89 is sized such that the phenolic piston can slide axially relative to the ball nut component 88. A hydraulic fluid chamber 84 is defined between the phenolic piston 89 and the caliper housing 74 (FIG. 4). Similar to the ball screw and nut assembly 54 described above, ball screw and nut assembly 82 is used during an electric park brake operation by extending and retracting the ball nut component 88 relative to the ball screw component 86 through rotation of the ball screw component in respective opposing directions relative to the ball nut component.

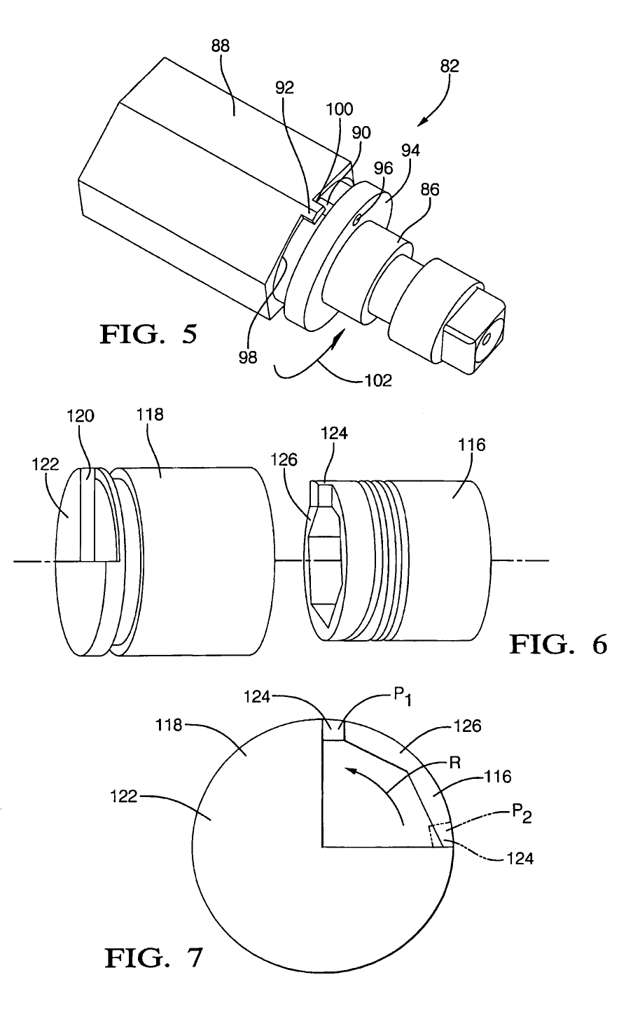

Referring now to FIG. 5, ball screw and nut assembly 82 includes cooperating stop members 90 and 92. Stop member 90 projects outwardly toward the ball nut component 88 from a flange 94. Stop member 90 is a pin that is disposed in an opening 96 extending through the flange 94. In some embodiments, stop member 90 may be formed integrally with the ball screw component 86. Stop member 92 projects outwardly toward the flange 94 from an end surface 98 of the ball nut component 88 and has a contact surface 100 located to engage stop member 90 as the ball nut component 88 is retracted, e.g., upon brake release.

The stop members 90 and 92 cooperate to prevent further rotation of the ball screw component 86 in the direction of arrow 102 relative to the ball nut component 88 once or soon after the stop members engage each other. This stopping of rotation by the stop members 90 and 92 also prevents additional axial retraction of the ball nut component 88 so that the ball nut component is prevented from fully retracting toward the ball screw component 86, which can prevent or inhibit jamming of the ball screw and nut assembly 82 as described above. The stop members 90 and 92, however, allow sufficient rotation of the ball screw component 86 and corresponding axial retraction of the ball nut component 88 so that the brake pad adequately disengages rotor disc (not shown).

Referring back to FIG. 4, during a service braking operation, the vehicle operator actuates the brake system resulting in an increase of hydraulic fluid pressure in one or more brake lines leading to the brake assembly. The increase in pressure of the hydraulic fluid in the brake line results in an increase of fluid in the fluid chamber 84, which can cause the phenolic piston 89 to extend relative to the ball nut component 88 within the caliper housing 74. Hydraulic pressure within the chamber 84 is sufficient to cause the phenolic piston 89 to move the brake pads (not shown) to engage a rotor (not shown). Seals 106 and 108 are provided for preventing or inhibiting the loss of hydraulic fluid and/or to maintain the angular position of the ball nut component 88 within the housing 74. Release of the brake pedal by the vehicle operator decreases the hydraulic fluid pressure within chamber 84 such that a biasing force applied by seal 108 retracts the phenolic piston 89 in a direction away from the rotor allowing the brake pads to disengage the rotor.

During an electric park brake operation, the vehicle operator can engage the park brake by some suitable means, such as by a switch, lever, button or remote control. In some embodiments, a control device such as an electronic brake control module or computer can engage the park brake automatically, e.g., when the vehicle is turned off or put into park. When the park brake operation is initiated, the electric motor 78 is activated, rotating the transmission 76 mechanically connected to ball screw component 86. Transmission 76 can be any suitable device for transmitting output from the motor 78 including, for example, meshed gears, chains, sprockets, pulleys, belts and the like. A threaded connection 114 between the ball screw component 86 and the ball nut component 88 translates the rotational movement of the ball screw component into linear movement of the ball nut component. In response to the rotational movement of the ball screw component 86, the ball nut component 88 moves axially toward the rotor and pushes the phenolic piston 89 toward the rotor until the phenolic piston actuates the brake pad to engage the rotor in a fashion similar to that described above. The brake pad can remain engaged with the rotor until the motor 78 is reversed. Reversal of the motor 78 causes the ball nut component 88 to retract, in some embodiments, independently of the phenolic piston 89. In these embodiments, the seal 108 can cause the phenolic piston 89 to retract relative to the ball nut component 88 to allow the brake pads to disengage the rotor.

A number of detailed embodiments have been described. Nevertheless, it will be understood that various modifications may be made. For example, while two ball screw and nut assembly examples are described above, other ball screw and nut assembly configurations may include a positive stop. A stop member, such as a pin, can be separately formed and then attached to the ball and nut screw assembly and/or a stop member can extend integrally from and be formed of the same material as the ball nut component or ball screw component. Additionally, other stop member configurations can be employed. For example, referring to FIGS. 6 and 7, ball nut component 118 includes a stop member 120 in the form of an arc-shaped opening that extends through an end wall 122. The arc shaped opening is arranged and located to receive a stop member 124 in the form of a projection that extends from an end 126 of ball screw component 116. The stop members 120 and 124 cooperate to limit the range of rotation of the ball screw component 116 along arc R between a home position P₁ and an extended position P₂. In some embodiments, P₁ and P₂ each provide respective positive stops that are located at positions between fully retracted and fully extended positions that could be achieved in the absence of one or both of the stop members 120 and 124. Accordingly, other embodiments are within the scope of the following claims.

What is claimed is:

1. A ball screw and nut assembly comprising:
a ball screw component having a threaded outer surface;
a ball nut component having a bore in which the ball screw component is received and a threaded inner surface that cooperates with the threaded outer surface of the ball screw component to achieve axial movement of the ball nut component between a fully retracted position and a fully extended position as the ball screw component rotates relative to the ball nut component; and
a positive stop that prevents rotation of the ball screw component relative to the ball nut component at an axial position between the fully retracted position and the fully extended position as the ball nut component is retracted.

2. The ball screw and nut assembly of claim 1 further comprising a first stop member associated with the ball screw component and a second stop member associated with the ball nut component, the first stop member and the second stop member arranged and configured to engage as the ball screw component rotates relative to the ball nut component to form the positive stop.

3. The ball screw and nut assembly of claim 2 wherein the first stop member comprises an extension that extends outwardly from the ball screw component.

4. The ball screw and nut assembly of claim 3 wherein the ball nut component has a step that defines a seating surface for engaging the extension.

5. The ball screw and nut assembly of claim 3 wherein the second stop member comprises a projection for engaging the extension.

6. The ball screw and nut assembly of claim 2 wherein the ball screw component includes a flange spaced apart axially from the ball nut component, the first stop member comprising an extension extending from the flange toward the ball nut component, the second stop member comprising a projection extending from an edge of the ball nut component toward the flange.

7. A brake apparatus comprising:
a housing;
a ball screw component disposed in the housing and having a threaded outer surface;
a ball nut component disposed in the housing and having a bore in which the ball screw component is received, the ball nut component including a threaded inner surface that cooperates with the threaded outer surface of the ball screw component to achieve axial movement of the ball nut component between a fully retracted position and a fully extended position as the ball screw component rotates relative to the ball nut component; and
a positive stop that prevents rotation of the ball screw component relative to the ball nut component at an axial position between the fully retracted position and the fully extended position as the ball nut component is retracted.

8. The brake apparatus of claim 7 further comprising a first stop member associated with the ball screw component and a second stop member associated with the ball nut component, the first stop member and the second stop member arranged and configured to engage as the ball screw component rotates relative to the ball nut component to form the positive stop.

9. The brake apparatus of claim 8 wherein the first stop member comprises an extension that extends outwardly from the ball screw component.

10. The brake apparatus of claim 9 wherein the ball nut component has a step that defines a seating surface for engaging the extension.

11. The brake apparatus of claim 9 wherein the second stop member comprises a projection for engaging the extension.

12. The brake apparatus of claim 8 wherein the ball screw component includes a flange spaced apart axially from the ball nut component, the first stop member comprising an extension extending from the flange toward the ball nut component, the second stop member comprising a projection extending from an edge of the ball nut component toward the flange.

13. The brake apparatus of claim 8 further comprising a controller coupled to at least one of the ball screw component and the ball nut component, the controller configured to receive a signal indicating that the first and second stop members are engaged.

14. The brake apparatus of claim 7 further comprising a motor that is operatively connected to the ball screw component for rotating the ball screw component.

15. The brake apparatus of claim 7 further comprising a projection extending outwardly from the ball nut component and received in an opening of the housing to prevent rotation of the ball nut component as the ball screw component rotates.

16. The brake apparatus of claim 15 further comprising a damping member arranged and configured to dampen force applied to the projection received by the opening during operation.

17. The brake apparatus of claim 7 further comprising a phenolic piston having a bore in which the ball nut component is received.

18. A method of actuating a brake caliper during a braking operation, the method comprising:
extending a ball nut component of a ball screw and nut assembly relative to a ball screw component by rotating the ball screw component in a first direction relative to the ball nut component;
retracting the ball nut component of the ball screw and nut assembly relative to the ball screw component toward a fully retracted position by rotating the ball screw component in a second direction opposite the first direction relative to the ball nut component; and
stopping rotation of the ball screw component in the second direction using a positive stop thereby stopping axial retraction of the ball nut component relative to the ball screw component prior to the ball nut component reaching the fully retracted position.

19. The method of claim 18 wherein the step of stopping rotation of the ball screw component includes engaging a respective stop member associated with the ball screw component and the ball nut component, the stop members cooperating when engaged to stop the rotation of the ball screw component relative to the ball nut component prior to the ball nut component reaching the fully retracted position.

20. The method of claim 19 further comprising detecting when the stop members are engaged.
